(19) United States
(12) Patent Application Publication
(10) Pub. No.: US 2024/0369359 A1
(43) Pub. Date: Nov. 7, 2024

(54) REMOTE SENSING ASSESSMENT METHOD FOR SOIL EROSION CONTROL DEGREE BASED ON MAXIMUM EROSION POTENTIAL

(71) Applicant: Henan University, Kaifeng (CN)

(72) Inventors: Xiwang Zhang, Kaifeng (CN); Jiayi Liu, Hebi (CN); Kailin Gao, Zhengzhou (CN); Hao Zhao, Hebi (CN); Shiqi Yu, Zhengzhou (CN); Mengwei Chen, Xingtai (CN); Yuhui Cheng, Linzhou (CN)

(21) Appl. No.: 18/513,654

(22) Filed: Nov. 20, 2023

(30) Foreign Application Priority Data
May 6, 2023 (CN) 2023105151562

(51) Int. Cl. G01C 15/00

(52) U.S. Cl. CPC G01C 15/00

(57) ABSTRACT

A remote sensing assessment method for soil erosion control degree based on maximum erosion potential includes: data preparation and process, and determining a current soil erosion modulus, a maximum possible soil erosion modulus, and a soil erosion control degree. A soil erosion modulus is determined as the maximum possible soil erosion modulus of a research area under a condition that a most serious water and soil loss possibly occurs; the maximum possible and the current soil erosion moduli are calculated by using a USLE model; and a ratio of a difference between the maximum possible and the current soil erosion moduli to the maximum possible soil erosion modulus is determined as the soil erosion control degree. Therefore, the soil erosion control degree is representative and popularized to measure soil management potential, which improves evaluation efficiency thereof and provides an important reference for further adjusting soil erosion management measures.

### TECHNICAL FIELD

The disclosure relates to the field of soil erosion monitoring by remote sensing technologies, particularly to a remote sensing assessment method for soil erosion control degree based on maximum erosion potential.

### BACKGROUND

Soil erosion refers that physical structures or chemical components of the soil or soil parent material occurs destruction or displacement under the action of external forces such as water force, wind power, freeze-thaw, gravity, temperature, artificially, etc., especially including processes of destruction, denudation, transportation, deposition, etc. except for permanently frozen areas, most regions around the world have experienced or are currently experiencing varying degrees of soil erosion. A universal soil loss equation (USLE) can be used to quantitatively evaluate the soil erosion status of a research area on a large scale. With regard to characterization of the degree of drainage basin management, an index mainly used in the existing research is water and soil loss management degree, that is, “in a certain area, a ratio of water and soil loss management area accounting for original water and soil loss area”. However, the index cannot accurately represent the water and soil loss management degree, because in some basins, the water and soil loss management degree reaches 100%, but water and soil loss still needs to be further managed in these basins. Scholars propose to use a ratio of minimum possible soil erosion modulus to current soil erosion modulus to characterize soil erosion control degree, and the ratio may reflect management degree of soil erosion in the drainage basin. However, a large amount of field monitoring data is required for auxiliary determination by using the foregoing method in an appropriate distribution area, such as a dam land, a terraced field, and a forest land; and the minimum possible soil erosion modulus in many areas without detailed data is difficult to calculate, so that the efficiency of evaluating the soil erosion control degree is relatively low, and therefore, the foregoing method is difficult for wide application.

### SUMMARY

The disclosure is partially used to introduce concepts in a brief form that will be described in detail in the following embodiments. This part of the disclosure is not intended to identify key features or essential features of technical solutions of the disclosure, nor is it intended to be used to limit the scope of the technical solutions.

In order to solve the technical problem of low efficiency of evaluating the soil erosion control degree, the disclosure provides a remote sensing assessment method for soil erosion control degree based on maximum erosion potential.

The disclosure provides the remote sensing assessment method for soil erosion control degree based on maximum erosion potential, including the following steps:
obtaining digital elevation model data, normalized difference vegetation index data, land use data, soil data, and rainfall data of a research area;
determining a current soil erosion modulus of the research area according to the digital elevation model data, the normalized difference vegetation index data, the land use data, the soil data, and the rainfall data of the research area;
determining a maximum possible soil erosion modulus of the research area; and
determining a soil erosion control degree of the research area according to the current soil erosion modulus and the maximum possible soil erosion modulus of the research area.

In an embodiment, the determining the current soil erosion modulus of the research area according to the digital elevation model data, the normalized difference vegetation index data, the land use data, the soil data, and the rainfall data of the research area includes the following steps:
determining a rainfall-runoff erosivity factor, a soil-erodibility factor, a slope-length factor, a slope-gradient factor, a cover-management factor, and a support practices factor of the research area according to the digital elevation model data, the normalized difference vegetation index data, the land use data, the soil data, and the rainfall data of the research area; and
determining the current soil erosion modulus of the research area according to the rainfall-runoff erosivity factor, the soil-erodibility factor, the slope-length factor, the slope-gradient factor, the cover-management factor, and the support practices factor of the research area.

In an embodiment, a formula for determining the current soil erosion modulus of the research area is as follows:

T_{S}=R·K·L·S·C·P;

and in the formula, T_{S} represents the current soil erosion modulus of the research area, R represents the rainfall-runoff erosivity factor of the research area, K represents the soil-erodibility factor of the research area, L represents the slope-length factor of the research area, S represents the slope-gradient factor of the research area, C represents the cover-management factor of the research area, and P represents the support practices factor of the research area.

In an embodiment, the determining the maximum possible soil erosion modulus of the research area includes the following steps:
obtaining rainfall-runoff erosivity factors, water and soil support practices factors, and cover-management factors of the research area in a preset time period, extracting corresponding maximum values of the rainfall-runoff erosivity factors, the water and soil support practices factors, and the cover-management factors of the research area to obtain statistics results, and determining the maximum possible soil erosion modulus of the research area by using a universal soil loss equation according to the statistics results.

In an embodiment, a formula for determining the soil erosion control degree of the research area is as follows:

$$r = ( {T}_{M} - {T}_{S} ) / {T}_{M} .$$

In the aforementioned formula, r represents the soil erosion control degree of the research area. T_{S} represents the current soil erosion modulus of the research area, and T_{M} represents the maximum possible soil erosion modulus of the research area.

In an embodiment, the method provided by the disclosure further includes:
determining a soil erosion management measure of the research area based on the soil erosion control degree of the research area, and thereby, managing, by soil management personnel, the research area based on the soil erosion management measure.

In an embodiment, the method provided by the disclosure is implemented by a remote sensing assessment device including: a processor and a memory with a remote sensing assessment application stored therein; the remote sensing assessment application, when executed by the processor, is configured to implement the remote sensing assessment method and is further configured to send, over the Internet, the soil erosion management measure to a mobile terminal of the soil management personnel; and an application installed in the mobile terminal is configured to: receive the soil erosion management measure, and display the soil erosion management measure on the mobile terminal to assist the soil management personnel to manage the research area based on the soil erosion management measure.

The disclosure has the following beneficial effects:

The disclosure proposes to use the maximum possible soil erosion modulus of the research area to calculate the soil erosion control degree of the research area. The ratio of a difference between the maximum possible soil erosion modulus and the current soil erosion modulus of the research area to the maximum possible soil erosion modulus of the research area is used to determine the soil erosion control degree of the research area. And then, the ratio is also used to characterize the degree of soil erosion management potential, making up for the shortcomings of difficult determination of suitable distribution areas and minimum possible soil erosion moduli in the dam land, the terraced field, and the forest land. Furthermore, the method provided by the disclosure makes the soil erosion control degree characterizing the degree of soil erosion management potential more representative, and improves evaluation efficacy of the soil erosion control degree while providing important reference for the soil erosion management. Compared to using the minimum possible soil erosion modulus to calculate the soil erosion control degree, detailed data on soil and water support practices is not required and the maximum possible soil erosion modulus is easy to determine. Therefore, the method provided by the disclosure has good promotion and application value.

### BRIEF DESCRIPTION OF DRAWINGS

In order to more clearly illustrate technical solutions and advantages of embodiments of the disclosure or the related art, attached drawings that need to be used in the embodiments or the related art are briefly described below. Apparently, the attached drawings in the following description are merely some embodiments of the disclosure, and those skilled in the related art may obtain other drawings according to these attached drawings without involving any inventive effort.

FIG. 1 illustrates a flowchart of a remote sensing assessment method for soil erosion control degree based on maximum erosion potential according to the disclosure.

FIG. 2 illustrates another flowchart according to the disclosure.

FIG. 3 illustrates a schematic diagram of a spatial distribution of soil erosion grading of Dali river basin in 2020 according to the disclosure.

FIG. 4 illustrates a schematic diagram of a spatial distribution of maximum possible soil erosion grading of the Dali river basin according to the disclosure.

FIG. 5 illustrates a schematic diagram of a spatial distribution of a soil erosion control degree of the Dali river basin in 2020 according to the disclosure.

FIG. 6 is a schematic diagram of a tendency of an average value of a soil erosion modulus of the Dali river basin from 2001 to 2020 according to the disclosure.

FIG. 7 is a schematic diagram of a spatial distribution of a soil erosion control degree of the Dali river basin in 2001 according to the disclosure.

### DETAILED DESCRIPTION OF EMBODIMENTS

In order to further explain the technical solutions and technical effects described in the disclosure that are used to achieve predetermined objectives of the disclosure, specific implementation modes, structures, features, and effects of the technical solutions provided by the disclosure are describes below in details with reference to the attached drawings and illustrated embodiments. In the following description, “an embodiment” or “another embodiment” described therein not refers to a same embodiment. Furthermore, particular features, structures, or characteristics in one or more embodiments may be combined in any suitable form.

Unless otherwise defined, all of the technical and scientific terms used herein have the same meaning as commonly understood by those skilled in the related art to which the present disclosure belongs.

The disclosure provides a remote sensing assessment method for soil erosion control degree based on maximum erosion potential, including the following steps:
obtaining digital elevation model data, normalized difference vegetation index data, land use data, soil data, and rainfall data of a research area;
determining a current soil erosion modulus of the research area according to the digital elevation model data, the normalized difference vegetation index data, the land use data, the soil data, and the rainfall data of the research area;
determining a soil erosion control degree of the research area according to the current soil erosion modulus and the maximum possible soil erosion modulus of the research area.

The following describes the aforementioned steps in detail.

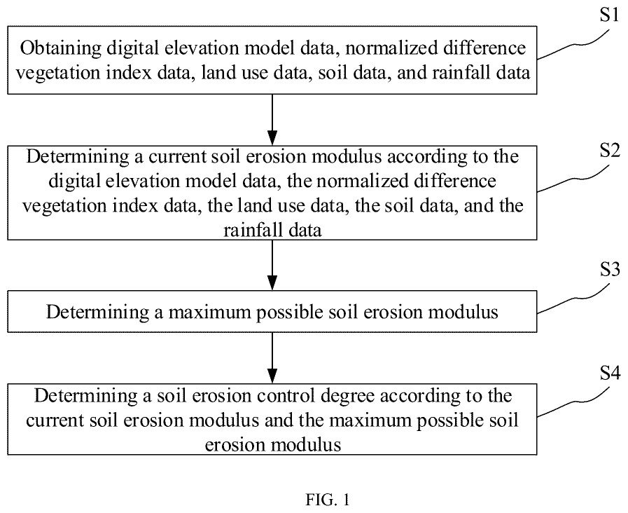

With reference to FIG. 1, a flowchart of some embodiments of the remote sensing assessment method for soil erosion control degree based on maximum erosion potential according to the disclosure is illustrated. The remote sensing assessment method for soil erosion control degree based on maximum erosion potential includes the following steps:

Step 1, the digital elevation model data, the normalized difference vegetation index data, the land use data, the soil data, and the rainfall data of the research area are obtained.

In some embodiments, the digital elevation model (DEM) data, the normalized difference vegetation index (NDVI) data, the land use data, the soil data, and the rainfall data of the research area can be obtained. The aforementioned data required by the research area is sheared by using GIS software (also referred to as geographic information system, i.e., ArcGIS, a suite of applications and tools for mapping, analyzing, and managing geographic data), spatial resolution is unified for the sheared data, and then the unified data is fully registered in a projection and coordinate system, so as to provide support for subsequent calculation.

The research area can be a region to be subjected to soil erosion control degree remote sensing evaluation. The DEM data, the NDVI data, the land use data, the soil data, and the rainfall data of the research area belong to relative materials of the research area.

The used data (also referred to as the unified data) includes: the DEM data obtained from processing data based on ASTGTM (referred to as a global digital elevation model of land areas on Earth at a spatial resolution of 1 arc second) with a resolution of 30 meter (m); soil physicochemical property data with a resolution of 30 m based on harmonized world soil database (HWSD); the NDVI data with a resolution of 30 m processed according to Landsat images (referred to as a kind of remote sensing data); the land use data with a resolution of 30; the rainfall data with a resolution of 1 kilometer (km). The spatial resolution of the rainfall data is set to 30 m by using a resampling tool, and the coordinate system for the used data is unified to world geodetic system (i.e., WGS1984).

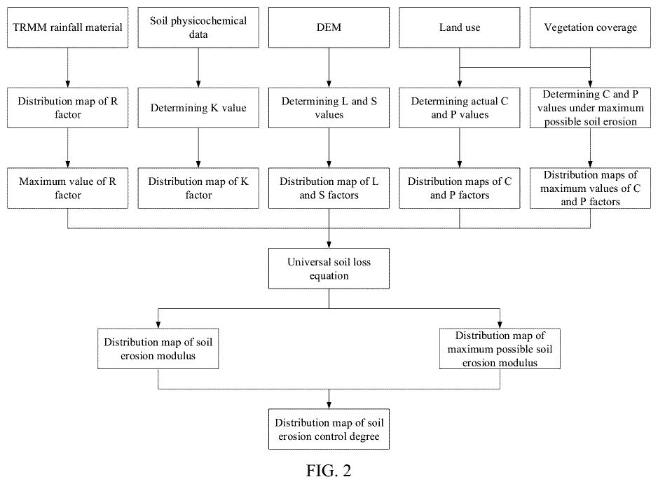

Another flowchart of the disclosure is illustrated in FIG. 2, for example, a Dali river basin is determined as the research area. Specially, calculation methods for each factor are first determined according to the research area, a distribution map of soil erosion factors of the Dali river basin in 2020 is calculated by using the ArcGIS, and then a distribution map of soil erosion modulus of the Dali river basin in 2020 is obtained, that is, a distribution map of the current soil erosion modulus of the research area. Next, distribution maps of the soil erosion modulus of the Dali river basin from 2001 to 2020 are calculated, and then, a distribution map of the maximum possible soil erosion modulus of the research area is calculated by using a pixel statistical tool in the ArcGIS, that is, the maximum possible soil erosion modulus of the Dali river basin in the recent years. Finally, according to the method for determining the soil erosion control degree provided by the disclosure, the soil erosion control degree of the Dali river basin in 2020 can be calculated.

Step 2, the current soil erosion modulus of the research area is determined according to the digital elevation model data, the normalized difference vegetation index data, the land use data, the soil data, and the rainfall data of the research area.

In some embodiments, the current soil erosion modulus of the research area can be determined according to the digital elevation model data, the normalized difference vegetation index data, the land use data, the soil data, and the rainfall data of the research area.

Specially, the step 2 includes: determining a rainfall-runoff erosivity factor, a soil-erodibility factor, a slope-length factor, a slope-gradient factor, a cover-management factor, and a support practices factor of the research area according to the digital elevation model data, the normalized difference vegetation index data, the land use data, the soil data, and the rainfall data of the research area.

Specially, according to the relative materials of the research area, each of the aforementioned factors is determined by using the following steps:
determining the rainfall-runoff erosivity factor according to the following formula:

$$R = {Σ}_{i = 1}^{12} 1.735 \times 1 {0}^{1.5 log ( \frac{{p}_{{i}^{2}}}{p} ) - 0.08188} ,$$

where R represents the rainfall-runoff erosivity factor and reflects power magnitude of soil erosion caused by rainfall, and a unit thereof is MJ·mm/(hm²·h); pᵢ represents an amount of a monthly rainfall of the research area, and a unit thereof is millimeters (mm); and p represents an amount of an annual rainfall of the research area, and a unit thereof is mm.

A formula for determining the soil-erodibility factor is as follows:

k={2.1*10⁻⁴*(12−α)*[soil_{powder}*(100−soil_{clay})]^{1.14}+3.25*(b−2)+2.5*(c−3)}/100,

where K represents the soil-erodibility factor, represents an amount of soil loss per unit area caused by per unit rainfall-runoff erosivity under a standard area, and a unit thereof is t·h/(MJ·mm); soil_{powder} and soil_{clay} represent percentage contents of clay particles and powder particles in the soil, respectively; a and b represent a soil structure level and a penetration level, respectively.

A formula for determining the slope-length factor is as follows:

$$L = {( \frac{λ}{22.1} )}^{c} ,$$

where L represents the slope-length factor, λ represents a slope length with a unit of meter (m), and c represents a slope length index.

A formula for determining the slope-gradient factor is as follows:

$$S = \{ \begin{matrix}10.8 sin θ + 0.03 & θ < {5}^{∘} \\ 16.8 sin θ & {5}^{∘} \leq θ < 1 {0}^{∘} \\ 21.91 sin θ & θ \geq 1 {0}^{∘}\end{matrix} .$$

In the above formula, S represents the slope-gradient factor and θ represents a slope gradient.

A formula for determining the cover-management factor is as follows:

C=exp[−α×NDVI/(β−NDVI)],

where C represents the cover-management factor and also refers to a vegetation cover factor, which refers to a factor reflecting an influence of the vegetation on soil loss according to different ground vegetation coverage conditions; α and β represent dimensionless factors, where α is equal to 1 and β is equal to 2; and NDVI represents a value of the NDVI of the research area.

A method for determining the support practices that is also referred to as a water and soil support practices factor is as follows: assigning the forest land, grassland, and bare land to be 1, assigning building land and water area to be 0, and performing grading assignment on cultivated land according to a gradient thereof.

In the universal soil loss equation (USLE) model, P values representing different gradients of the cultivated land are illustrated as Table 1.

TABLE 1

| Slope gradient/(°) | ≤5 | 5-10 | 10-15 | 15-20 | 20-25 | >25 |
|---|---|---|---|---|---|---|
| P value | 0.11 | 0.22 | 0.31 | 0.58 | 0.74 | 0.80 |

The step 2 further includes: determining the current soil erosion modulus of the research area according to the rainfall-runoff erosivity factor, the soil-erodibility factor, the slope-length factor, the slope-gradient factor, the cover-management factor, and the support practices factor of the research area.

For example, the USLE model is used to calculate the current soil erosion modulus of the research area, and the USLE model comprehensively considers the influence of natural elements on the soil erosion and the considerations of the USLE model comprehensively reflected in the rainfall-runoff erosivity factor, the soil-erodibility factor, the slope-gradient factor, the slope-length factor, the cover-management factor, and the support practices factor. Specially, a formula for determining the current soil erosion modulus of the research area is as follows:

T_{S}=R·K·L·S·C·P, where T_{S} represents the current soil erosion modulus of the research area, also represents an annual soil erosion modulus, and reflects an annual average erosion amount per unit area of slope sheet erosion and rill erosion with a unit of t·km⁻²·a⁻¹; R represents the rainfall-runoff erosivity factor and reflects the power magnitude of the soil erosion caused by rainfall with a unit of MJ·mm/(hm²·h); K represents the soil-erodibility factor and reflects a soil loss amount per unit area caused by a unit rainfall erosion force in a standard area with a unit of t·h/(MJ·mm); L represents the slope-length factor; and S represents the slope-gradient factor. Generally, the slope-length factor L and the slope-gradient factor S are combined into LS for consideration; C represents the cover-management factor and refers to a factor reflecting the influence of the vegetation on soil loss according to different ground vegetation coverage conditions; and P represents the support practices factor and mainly reflects a reduction effect on erosion after the water and soil support practices are implemented.

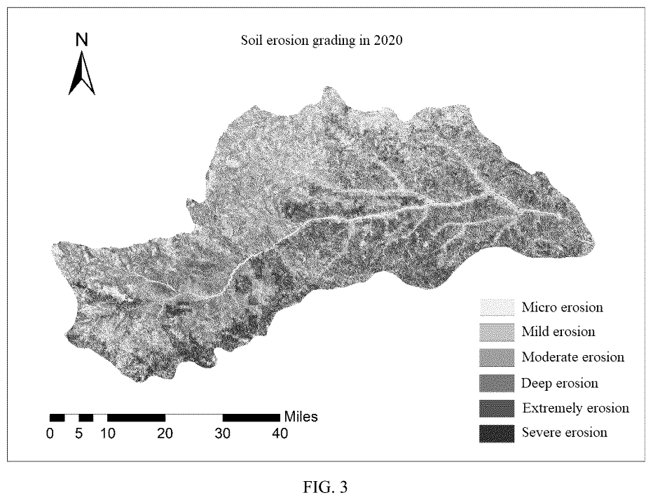

The above-mentioned method is applied to the research area, and the Dali river basin is used as the research area, so that the soil erosion modulus of the Dali river basin in 2020 can be obtained, and calculation results are shown in FIG. 3.

Step 3, the maximum possible soil erosion modulus of the research area is determined.

In some embodiments, rainfall-runoff erosivity factors, water and soil support practices factors, and cover-management factors of the research area in a preset time period can be obtained, corresponding maximum values of the rainfall-runoff erosivity factors, the water and soil support practices factors, and the cover-management factors of the research area are extracted to obtain statistics results, and the maximum possible soil erosion modulus of the research area is determined by using a universal soil loss equation according to the statistical results.

Specially, the preset time period is a predetermined time period. The maximum possible soil erosion modulus of the research area refers to the soil erosion modulus of a certain area (also referred to as the research area) under a condition of the most serious water and soil loss. Namely, the maximum possible soil erosion modulus of the research area is equal to the soil erosion modulus under the condition that the rainfall-runoff erosivity factors, the water and soil support practices factors, and the cover-management factors of the certain area are all assumed to reach the corresponding maximum values in a long time series.

In an illustrated embodiment, year-by-year data of the rainfall-runoff erosivity factors, the water and soil support practices factors, and the cover-management factors of the research area during the long time series are first sorted by means of the ArcGIS. Then, the maximum values of the aforementioned factors are extracted by using the “pixel statistical data” tool, which are used as a lower limit of the soil erosion management degree. Finally, the soil erosion modulus of the research area is determined by using the USLE model, thereby obtaining the distribution map of the maximum possible soil erosion modulus of the research area.

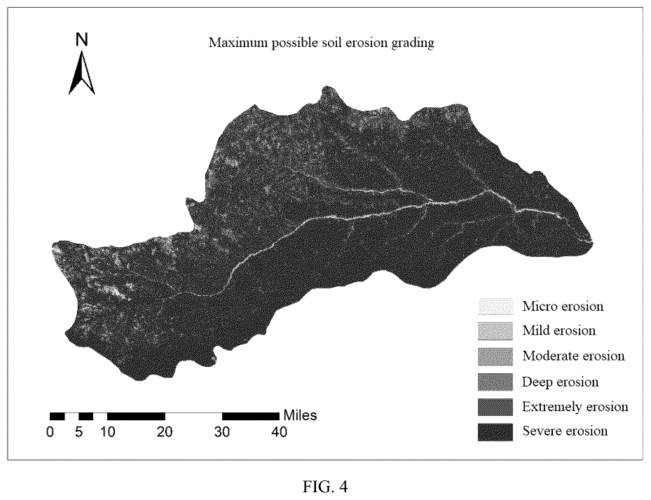

Specifically, the Dali river basin is used as the research area, the distribution maps of the rainfall-runoff erosivity factors, the water and soil support practices factors, and the cover-management factors of the Dali river basin from 2001 to 2020 are respectively calculated, and then the maximum values of the rainfall-runoff erosivity factors, the water and soil support practices factors, and the cover-management factors in each year are obtained by using the pixel statistical tool in the GIS, thereafter obtaining the distribution map of the maximum possible soil erosion modulus of the research area by using the USLE model, and obtaining the calculation results illustrated in FIG. 4.

Step 4, the soil erosion control degree of the research area is determined according to the current soil erosion modulus and the maximum possible soil erosion modulus of the research area.

In some embodiments, the soil erosion control degree of the research area can be determined according to the current soil erosion modulus and the maximum possible soil erosion modulus of the research area.

Specially, the soil erosion control degree of the research area is determined as the ratio of the difference between the maximum possible soil erosion modulus and the current soil erosion modulus of the research area to the maximum possible soil erosion modulus of the research area.

A formula for determining the soil erosion control degree of the research area is as follows:

r=(T_{M}−T_{S})/T_{M},

where r represents the soil erosion control degree of the research area and is dimensionless; T_{S} represents the current soil erosion modulus of the research area with a unit of t·km⁻²·a⁻¹; and Ty represents the maximum possible soil erosion modulus of the research area with a unit of t· km⁻²·a⁻¹.

It should be noted that the soil erosion control degree of the research area should fall between 0 and 1, actually reflecting capacity proximity of the water and soil support practices. Moreover, when the soil erosion control degree of the research area is closer to 1, it is indicated that the soil erosion management degree of the research area is higher; and when the soil erosion control degree of the research area is closer to 0, it is indicated that the soil erosion management degree of the research area is lower, that is, far way the ideal management status. Therefore, the soil erosion control degree of the research area actually expresses the potential of regulating the soil erosion of the research area and further provides an important basis for adjusting soil erosion management measures.

Moreover, due to the fact that the soil erosion control degree of the research area is determined as the ratio of the difference between the maximum possible soil erosion modulus and the current soil erosion modulus of the research area to the maximum possible soil erosion modulus of the research area, the current soil erosion modulus of the research area is thereby determined by using the step 2 and the maximum possible soil erosion modulus of the research area is thereby determined by using the step 3. Furthermore, the soil erosion control degree of the research area is therefore obtained.

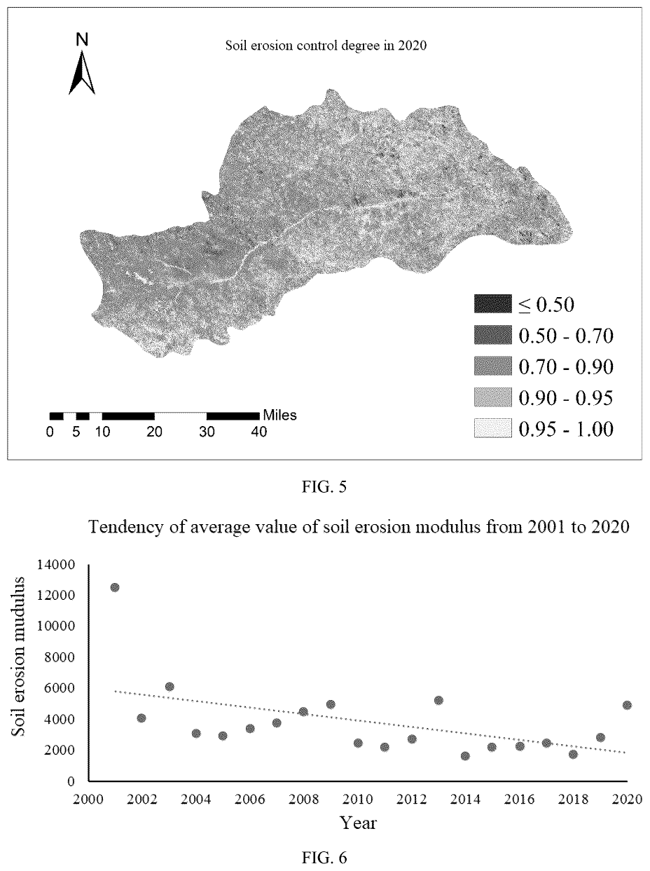

Specifically, the Dali river basin is determined as the research area, the difference between the maximum possible soil erosion modulus and the current soil erosion modulus of the Dali river basin in 2020 is compared with the maximum possible soil erosion modulus of the Dali river basin, thereby obtaining the distribution map of the soil erosion control degree of the Dali river basin, falling between 0 to 1 and reflecting the capacity proximity for the water and soil support practices. Moreover, when the soil erosion control degree of the Dali river basin is closer to 1, it is indicated that the soil erosion management degree of the research area is higher; and when the soil erosion control degree of the Dali river basin is closer to 0, it is indicated that the soil erosion management degree of the Dali river basin is lower, namely, faring away the ideal management status, so that the characterization of the soil erosion management potential is achieved, and the calculation result is shown in FIG. 5.

It should be noted that, in order to verify the calculation practicability of the soil erosion control degree of the research area with the maximum possible soil erosion modulus of the research area instead of the minimum possible soil erosion modulus of the research area, the researcher compares the average value of soil erosion of the research area with the tendency of the soil erosion control degree of the research area, indicating that the practicability of the soil erosion management potential is measured by the soil erosion control degree of the research area, and is briefly introduced as follows.

The Dali river basin is determined as the research area, the average values of the soil erosion modulus of the Dali river basin from 2001 to 2020 are obtained, then a diagram of the tendency is established, judging whether the soil erosion tends to be serious or slowed down during the time period from 2001 to 2020, and the calculation result is illustrated in FIG. 6. The soil erosion control degree calculated in 2001 is compared with that in 2020. The percentages of different control degree intervals in 2020 and 2001 are shown in Table 2.

TABLE 2

| Control degree | Year 2020/(%) | Year 2001/(%) |
|---|---|---|
| 1-0.95 | 0.56 | 2.89 |
| 0.95-0.90 | 4.09 | 57.05 |
| 0.90-0.70 | 46.84 | 27.20 |
| 0.70-0.5 | 27.04 | 8.75 |
| ≤0.5 | 21.48 | 4.1 |

In conclusion, the Dalian river basin is used as the research area, the soil erosion modulus of the Dalian river basin from 2001 to 2020 is slowed down, and the soil erosion control degree in 2001 is obviously higher than 2020. The Dalian river basin is one of the most intense drainage basins of loess plateau soil erosion, the soil erosion management measures are performed frequently, and the soil erosion control degree in 2020 is obviously lower than that in 2001, indicating that the soil erosion control degree can clearly reflect the effect of soil erosion management measures. According to the disclosure, the soil erosion control degree is calculated by using the maximum possible soil erosion modulus, the defects that the proper distribution area data of the dam land, the terraced field, and the forest land are difficult to obtain and the minimum possible soil erosion modulus is difficult to determine are overcome, the regional soil erosion management condition can be reflected without detailed water and soil support data, and the method has good popularization and application values.

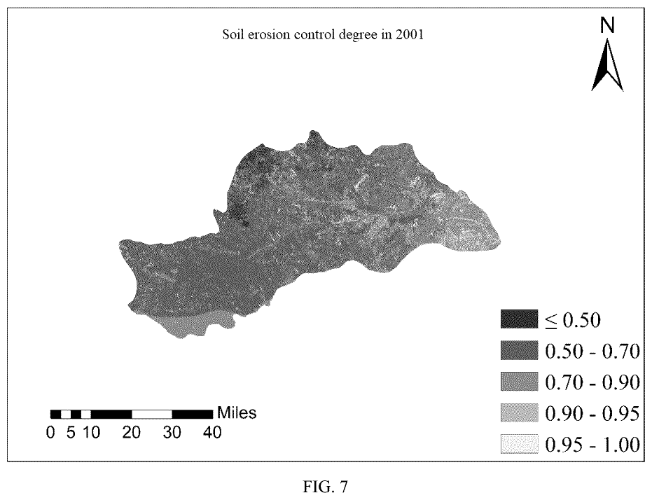

The spatial distribution of the soil erosion control degree of the Dali river basin in 2001 is illustrated in FIG. 7.

The soil erosion is a soil body migration process occurring under a specific space-time condition, which is comprehensively influenced by multiple natural elements and human activities, and causes a series of environmental problems. Specially, the water and soil loss is one of the most important problems among the environmental problems. In order to restrain the environmental problems such as the water and soil loss and improve the ecological environment, a series of water and soil support practices such as adjusting a land utilization structure, restoring vegetation, improving a cultivation mode, constructing a terrace on a slope surface, building a silt dam in a channel, etc. are adopted, and a concept of a quantitative management degree is needed for soil environment evaluation after implementing the measures, and many scholars have researched on the quantitative management degree. With regard to characterizing the drainage basin management degree, the currently used index is mainly an erosion control ratio, which is expressed as “in a certain research area, a percentage of an area (including the drainage basin) performed by the water and soil loss management measures accounting for an original water and soil loss area” in the terminology of water and soil conservation (GB/T20465-2006). The ratio between areas performed by the measures and not performed by the measures can only be used as an ideal result for the water and soil management, and cannot truly represent the improvement degree of the management measures on soil erosion in a specific area. However, the soil erosion control degree represents the management benefit of the soil erosion in the research area by using the ratio of the current soil erosion modulus to the minimum possible soil erosion modulus, which can further reflect the spatial difference of the management measures on the dynamic improvement degree of the specific area and the management benefit, can provide reference for implementing water and soil loss management measures according to local conditions, and is an important basis for further adjusting drainage basin management measures.

However, for the concept of the above “soil erosion control degree”, the existing research methods still have the following problems. Firstly, the appropriate distribution areas of the dam land, the terraced field, and the forest land are difficult to determine. Secondly, the distribution data of different land use types can be obtained through remote sensing data, but how to formulate the standard of the proper distribution area and how to determine the appropriate area needs to be determined through field investigation and consider multiple natural factors. Thirdly, the proper distribution areas of different land use types have spatial difference and there are many areas that are performed by the water and soil loss management measures; however, the appropriate area for the specific type of land use cannot be directly applied to another type of land use, which makes it difficult to calculate the soil erosion control degree in a large scale. Therefore, the minimum possible soil erosion modulus is difficult to determine and is not easy to popularize.

Aiming at the problems that the existing research methods need to obtain the detailed data and are not easy to popularize and apply, the disclosure firstly determines the maximum possible soil erosion modulus as the soil erosion modulus of the certain area under the condition that the most serious water and soil loss possibly occurs; secondly uses the USLE model to calculate the maximum possible soil erosion modulus and the current soil erosion modulus; and thirdly, determines the ratio of the difference between the maximum possible soil erosion modulus and the current soil erosion modulus to the maximum possible soil erosion modulus as the soil erosion control degree. Specially, the maximum possible soil erosion modulus can be calculated and determined by means of the maximum values of the soil erosion influence factors during the long time series, which can be facilitated by making corrections according to the information of the research area. Therefore, the disclosure can not only make up the defects of difficult acquisition of appropriate distribution area data of the dam land, the terraced field, and the forest land, and difficult determination of the minimum possible soil erosion modulus, but also makes using the soil erosion control degree characterize the soil management potential more representative and generalization, and further provides an important reference for further adjusting the soil erosion management measures.

The above embodiments are merely used to illustrate the technical solutions of the disclosure, rather than limiting the technical solutions of the disclosure. Although the disclosure has been described in detail with reference to the foregoing embodiments, it should be understood by those skilled in the related art that they can still modify the technical solutions recited in the foregoing embodiments, or replace some of the technical features therein. However, these modifications or replacements do not make an essence of the corresponding technical solutions separate from the scope of the technical solutions of the embodiments of the disclosure, and should be included within the scope of the protection of the disclosure.

1. A remote sensing assessment method for soil erosion control degree based on maximum erosion potential, comprising the following steps:
obtaining digital elevation model data, normalized difference vegetation index data, land use data, soil data, and rainfall data of a research area;
determining a current soil erosion modulus of the research area according to the digital elevation model data, the normalized difference vegetation index data, the land use data, the soil data, and the rainfall data of the research area;
determining a maximum possible soil erosion modulus of the research area; and
determining a soil erosion control degree of the research area according to the current soil erosion modulus and the maximum possible soil erosion modulus of the research area, based on a formula expressed as follows:
$$r = ( {T}_{M} - {T}_{S} ) / {T}_{M} ,$$
where r represents the soil erosion control degree of the research area, T_{S} represents the current soil erosion modulus of the research area, and T_{M} represents the maximum possible soil erosion modulus of the research area;
wherein the method further comprises: applying the soil erosion control degree of the research area to characterize a soil erosion management degree of the research area which reflects an effect of soil erosion management measures for the research area.

2. The method according to claim 1, wherein the determining the current soil erosion modulus of the research area according to the digital elevation model data, the normalized difference vegetation index data, the land use data, the soil data, and the rainfall data of the research area comprises the following steps:
determining a rainfall-runoff erosivity factor, a soil-erodibility factor, a slope-length factor, a slope-gradient factor, a cover-management factor, and a support practices factor of the research area according to the digital elevation model data, the normalized difference vegetation index data, the land use data, the soil data, and the rainfall data of the research area; and
determining the current soil erosion modulus of the research area according to the rainfall-runoff erosivity factor, the soil-erodibility factor, the slope-length factor, the slope-gradient factor, the cover-management factor, and the support practices factor of the research area.

3. The method according to claim 2, wherein a formula for determining the current soil erosion modulus of the research area is as follows:
T_{S}=R·K·L·S·C·P,
wherein T_{S} represents the current soil erosion modulus of the research area, R represents the rainfall-runoff erosivity factor of the research area, K represents the soil-erodibility factor of the research area, L represents the slope-length factor of the research area, s represents the slope-gradient factor of the research area, c represents the cover-management factor of the research area, and p represents the support practices factor of the research area.

4. The method according to claim 1, wherein the determining the maximum possible soil erosion modulus of the research area comprises the following steps:
obtaining rainfall-runoff erosivity factors, water and soil support practices factors, and cover-management factors of the research area in a preset time period, extracting corresponding maximum values of the rainfall-runoff erosivity factors, the water and soil support practices factors, and the cover-management factors of the research area to obtain statistics results, and determining the maximum possible soil erosion modulus of the research area by using a universal soil loss equation according to the statistics results.

5-6. (canceled)

7. The method according to claim 1, wherein the method is implemented by a remote sensing assessment device including: a processor and a memory with a remote sensing assessment application stored therein; the remote sensing assessment application, when executed by the processor, is configured to implement the remote sensing assessment method and is further configured to send, over the Internet, the soil erosion management measure to a mobile terminal of the soil management personnel; and an application installed in the mobile terminal is configured to: receive the soil erosion management measure, and display the soil erosion management measure on the mobile terminal to assist the soil management personnel to manage the research area based on the soil erosion management measure.

8. A remote sensing assessment method for soil erosion control degree based on maximum erosion potential, comprising the following steps:
obtaining digital elevation model data, normalized difference vegetation index data, land use data, soil data, and rainfall data of a research area;
determining a current soil erosion modulus of the research area according to the digital elevation model data, the normalized difference vegetation index data, the land use data, the soil data, and the rainfall data of the research area, comprising:
determining a rainfall-runoff erosivity factor, a soil-erodibility factor, a slope-length factor, a slope-gradient factor, a cover-management factor, and a support practices factor of the research area according to the digital elevation model data, the normalized difference vegetation index data, the land use data, the soil data, and the rainfall data of the research area; and
determining the current soil erosion modulus of the research area according to the rainfall-runoff erosivity factor, the soil-erodibility factor, the slope-length factor, the slope-gradient factor, the cover-management factor, and the support practices factor of the research area, based on a formula expressed as follows:
$${T}_{S} = R \cdot K \cdot L \cdot S \cdot C \cdot P ,$$
where T_{S} represents the current soil erosion modulus of the research area, R represents the rainfall-runoff erosivity factor of the research area, K represents the soil-erodibility factor of the research area, L represents the slope-length factor of the research area, s represents the slope-gradient factor of the research area, c represents the cover-management factor of the research area, and p represents the support practices factor of the research area;
determining a maximum possible soil erosion modulus of the research area; and
determining a soil erosion control degree of the research area according to the current soil erosion modulus and the maximum possible soil erosion modulus of the research area;
adjusting a current soil erosion management measure of the research area based on the soil erosion control degree of the research area to obtain an adjusted soil erosion management measure, and applying the adjusted soil erosion management measure to the research area.

9. (canceled)
